(19) United States
(12) Patent Application Publication
(10) Pub. No.: US 2020/0165856 A1
(43) Pub. Date: May 28, 2020

(54) COUNTERBALANCE STRUT FOR VEHICLE CLOSURE PANEL LIFT SYSTEM HAVING AN ACTIVE BRAKE AND METHOD FOR COUNTERBALANCE STRUT AND SYSTEM CONTROL

(71) Applicant: MAGNA CLOSURES INC., Newmarket (CA)

(72) Inventors: Joseph SCHEURING, Richmond Hill (CA); Wieslaw NOWICKI, Mississauga (CA)

(21) Appl. No.: 16/698,487

(22) Filed: Nov. 27, 2019

Related U.S. Application Data
(60) Provisional application No. 62/772,166, filed on Nov. 28, 2018.

(51) Int. Cl. E05F 5/02; F16D 63/00; F16H 1/46; E05F 15/611

(52) U.S. Cl. CPC E05F 5/025; F16D 63/002; B60J 5/101; E05F 15/611; E05Y 2900/532; F16H 1/46

(57) ABSTRACT

A motor-less counterbalance strut for selectively braking pivotal movement of a closure member includes a housing connected to one of closure member and a motor vehicle body and an extensible member slideably moveable relative to housing connected to the other of closure member and motor vehicle body. The extensible member has a rotary drive member configured to drive a driven member and cause movement of extensible member between retracted and extended positions. A gearbox unit has an input operably driven by a rotary output of the rotary drive member and an output operably driven in response to the movement of the input. The output is fixed to a friction plate configured for operable communication with a brake rotor. An electro-mechanical actuator is operable to move brake rotor into and out of braking engagement with friction plate to establish a braking and non-braking condition of extensible member.

### CROSS-REFERENCE TO RELATED APPLICATION

This application claims the benefit of U.S. Provisional Application Ser. No. 62/772,166, filed Nov. 28, 2018, which is incorporated herein by way of reference in its entirety.

### FIELD

The present disclosure relates generally to closure panels for motor vehicles, and more particularly to motor-less struts having an active brake mechanism and method for applying a holding force to a closure panel to releasably hold the closure panel in an open position.

### BACKGROUND

This section provides background information which is not necessarily prior art to the inventive concepts associated with the present disclosure.

Automotive closure members, for example lift gates and side doors, provide a convenient access to the interior areas of a vehicle, for example to the cargo areas of hatchbacks, wagons, and other utility vehicles. A lift gate or side door can be hand operated, requiring manual effort to move the lift gate or door between open and the closed positions. Depending on the size and weight of the lift gate or door, this manual effort can be difficult for some users. Additionally, manually opening or closing a lift gate or side door can be inconvenient, particularly when the user's hands are full. In some cases, if the user slips or otherwise releases the lift gate or door, the lift gate or door can close suddenly, such as under a force of gravity, thereby causing frustration and/or risk of harm to the user.

Attempts have been made to reduce the effort and inconvenience of opening or closing a lift gate. One solution is to pivotally mount gas struts to both the vehicle body and the lift gate and which are operable to reduce the force required to open the lift gate. However, gas struts also hinder efforts to subsequently close the lift gate, as the struts re-pressurize upon closing, increasing the effort required to close the lift gate. Additionally, the efficacy of gas struts varies according to the ambient temperature, thereby adding a source of inconsistency to the effort required to open the lift gate.

Automated power closure systems used to open and close vehicle lift gates are well known in the art and typically include a power actuator that is operable to apply a force directly to the lift gate to enable opening and closing thereof. For example, U.S. Pat. No. 6,516,567 discloses a power actuator that works in tandem with a gas strut. The power actuator comprises an electric motor mounted within the vehicle body that is coupled to a flexible rotary cable by a clutch. The flexible rotary cable drives an extensible strut that is pivotally mounted to both the vehicle body and the lift gate. Thus, the electric motor can be controlled to raise and lower the lift gate conveniently without manual effort. A controller unit is operable to control actuation of the electric motor and can be in communication with a remote key fob button or a button in the passenger compartment, providing additional convenience. However, this type of power actuator is not without its disadvantages. Specifically, the power actuator is comprised of multiple parts, each of which needs to be assembled and mounted to the vehicle separately, increasing costs. The vehicle body must be specifically designed to provide a space to house the electric motor. Due to the limited space available, the motor is small and requires the assistance of the gas strut. Additionally, because the power actuator is designed to work in tandem with a gas strut, the gas strut can still vary in efficacy due to temperature. Thus, the electric motor must be sized to provide the correct amount of power to account for varying degrees of mechanical assistance from the gas strut.

U.S. Publication No. US2004/0084265 provides various examples of power actuators working in tandem with gas struts and several alternative examples of electromechanical power actuators. These electromechanical power actuators include an electric motor and reduction gearset coupled via a flexible rotary cable to a second gearset which, in turn, is coupled via a slip clutch to a rotatable piston rod. Rotation of the piston rod causes a spindle drive mechanism to translate an extensible strut that is adapted to be pivotally mounted to one of the vehicle body and the lift gate. The slip clutch functions to permit the piston rod to rotate relative to the gearset when a torque exceeding its preload is exerted on the lift gate so as to accommodate manual operation of the lift gate without damaging the electromechanical power actuator. More specifically, the slip clutch releasably couples the gearset to the piston rod whereby, during normal operation, powered opening and closing of the lift gate is provided. However, when a high level force is applied to the extensible strut which attempts to back drive the spindle drive mechanism in response to excessive or abusive manual operation of the lift gate, the slip clutch momentarily releases the drive connection between the piston rod and the gearset to avoid mechanical damage to the system. A helical compression spring is installed in the power actuator to provide a counter balancing force against the weight of the lift gate.

U.S. Publication No. US2012/0000304 discloses several embodiments of power drive mechanisms for moving trunk lids and lift gates between open and closed positions. The power drive mechanisms have an offset configuration employing an electric motor-driven worm gearset to rotate an externally-threaded jackscrew for translating an extensible strut. A slip clutch is shown to be disposed between an output gear of the worm gearset and the rotatable jackscrew. In addition, a coupler unit is provided between the motor output shaft and the worm of the worm gearset. The coupler unit includes a first coupler member fixed for rotation with the worm shaft, a second coupler member fixed for rotation with the motor output shaft, and a resilient spider interdigitated between fingers extending from the first and second coupler members. The resilient coupler provides axial and circumferential isolation between the first and second coupler members and functions to absorb transient or torsional shock loads between the motor shaft and the worm shaft.

In view of the above, it is evident that electromechanical drive mechanisms of the type used in trunk lid and lift gate powered closure systems are commonly equipped with a motor-driven gearbox. While such electromechanical drive mechanisms perform satisfactorily for their intended purpose, integration of these devices can increase the size, cost and complexity of powered actuators as well as impact the available vehicle packaging requirements.

It is therefore desired to provide an assembly for effectively braking movement of a closure member that obviates or mitigates at least one of the above-identified disadvantages of the prior art.

### SUMMARY

This section provides a general summary of the disclosure and is not a comprehensive disclosure of its full scope or all of its features, aspects or objectives.

It is an object of the present disclosure to provide an economical, compact mechanism and method for regulating movement of a closure member to prevent unwanted movement and/or regulate the speed of movement of the closure member between an open position and a closed position.

Accordingly, it is an aspect of the present disclosure to provide a motor-less strut having an active brake mechanism for controlling movement of a closure member between an open position and a closed position relative to a motor vehicle body.

It is a related aspect of the present disclosure to provide a motor-less strut having an active brake mechanism for use with a manually operated closure member in a motor vehicle.

It is a related aspect of the present disclosure to provide a motor-less strut having an active brake mechanism for use with a closure system in a motor vehicle including a power lift gate system.

It is a further aspect of the present disclosure to provide such motor-less strut including a gearbox unit having a dual-stage planetary geartrain configured to include a first stage gearset and a second stage gearset to enhance the braking power across the geartrain.

As a further aspect of the present disclosure, the dual-stage planetary geartrain of the gearbox unit is configured such that the second stage gearset is driven by a rotary output of a rotary-to-linear mechanism and the first stage gearset is driven by the second stage gearset, wherein the first stage gearset is configured for operable communication with a brake rotor, with the dual-stage planetary geartrain providing a torque and friction multiplication and speed reduction function between the rotary output of the rotary-to-linear actuator and the brake rotor to enhance the braking efficacy of the brake rotor when selectively brought into operable braking contact with the first stage gearset.

It is another aspect of the present disclosure to provide an electro-mechanical actuator configured to selectively move the brake rotor into and out of operable braking engagement with the first stage gearset.

It is another aspect of the present disclosure to provide the electro-mechanical actuator as a solenoid configured to move the brake rotor into operable braking engagement with the first stage gearset when de-energized to establish a braking condition and to move the brake rotor out from operable braking engagement with the first stage gearset when energized to establish a non-braking condition.

It is another aspect of the present disclosure to provide a control system in electrical communication with the electro-mechanical actuator to selectively energize the electro-mechanical actuator in response to receiving a signal from a sensor to establish the non-braking condition and to selectively de-energize the electro-mechanical actuator to establish the braking condition.

It is another aspect of the present disclosure to bias the brake rotor into operable braking engagement with the first stage gearset via a biasing member to establish the braking condition when the electro-mechanical actuator is de-energized.

It is another aspect of the present disclosure to provide the electro-mechanical actuator with an ability to overcome the bias of the biasing member when energized to establish the non-braking condition.

In accordance with an aspect of the present disclosure, a motor-less strut having an active brake mechanism for selectively braking movement of a pivotal closure member while in an open position is provided. The motor-less strut includes a housing connected to one of the closure member and the motor vehicle body. An extensible member is slideably moveable relative to the housing and is connected to the other of the closure member and the motor vehicle body. The extensible member has a driven member fixed thereto, wherein a rotary drive member is configured to drive the driven member and cause linear motion of the extensible member between a retracted position relative to the housing, corresponding to a closed position of the closure member, and an extended position relative to the housing, corresponding to the open position of the closure member. A gearbox unit is provided having an input configured for driven movement by a rotary output of the rotary drive member and an output configured for driven movement in response to the driven movement of the input. The output is operably (directly or indirectly via an intermediate connector mechanism) fixed to a friction plate configured for operable communication with a brake rotor, wherein the gearbox unit provides a torque and friction multiplication and speed reduction function between the input and the output. An electro-mechanical actuator is configured to selectively move the brake rotor into direct braking engagement with the friction plate to inhibit linear motion of the extensible member between the retracted position and the extended position and out of braking engagement from the friction plate to freely allow linear motion of the extensible member between the retracted position and the extended position.

It is yet another aspect of the present disclosure to provide the gearbox unit having a dual-stage planetary geartrain including a first stage gearset and a second stage gearset. The second stage gearset provides the input that is driven by the rotary output of the rotary drive member and the first stage gearset provides the output that is driven by the second stage gearset.

It is yet another aspect of the present disclosure to provide the gearbox unit including a gearbox housing adapted to be rigidly secured to a brake assembly housing of the active brake mechanism and which is configured to define a common ring gear. The first stage gearset of the dual-stage planetary geartrain can be provided including a first sun gear (also referred to as first pinion gear), a first planet carrier having a plurality of first pins, and a plurality of first planet gears each being rotatably supported on one of the first pins and in constant meshed engagement with the first sun gear and a first ring gear segment of the common ring gear. The second stage gearset of the dual-stage planetary geartrain can be provided including a second sun gear (also referred to as second pinion gear), a second planet carrier having a plurality of second pins rotatably driven by the rotary output of the rotary drive member, and a plurality of second planet gears each being rotatably supported on one of the second pins and in constant meshed engagement with the second sun gear and a second ring gear segment of the common ring gear. The second planet gears rotatably drive the second sun gear, which in turn rotatably drives the first planet carrier and first planet gears. The first planet gears rotatably drive the first sun gear, which is fixed to a friction plate. The friction plate is configured to be axially spaced from the brake rotor in a non-braking condition to allow the aforementioned relative rotation between the first and second planet gears, whereat the first and second sun gears and the first and second ring gear segments allow free pivotal movement of the closure member between open and closed positions.

In accordance with another aspect of the present disclosure, the first and second ring gear segments of the common ring gear can be configured to define a continuous helical gear tooth pattern adapted to mesh with helical first planet gears and helical second planet gears which, in turn, respectively mesh with helical first and second sun gears.

In accordance with another aspect of the present disclosure, a method of providing braking to pivotal movement of a closure member of a motor vehicle while in an open position is provided. The method includes providing a motor-less strut having a housing connected to one of the closure member and a motor vehicle body. Providing an extensible member that is slideably moveable relative to the housing and is connected to the other of the closure member and the motor vehicle body. Providing the extensible member with a driven member fixed thereto, and a rotary drive member configured to drive the driven member and cause linear motion of the extensible member between a retracted position relative to the housing, corresponding to a closed position of the closure member, and an extended position relative to the housing, corresponding to the open position of the closure member. Providing a gearbox unit having a dual-stage planetary geartrain including a first stage gearset and a second stage gearset. Configuring the second stage gearset to be driven by a rotary output of the rotary drive member and configuring the first stage gearset to be driven by the second stage gearset. Fixing the first stage gearset to a friction plate, and configuring the friction plate for operable communication with a brake rotor. Configuring an electro-mechanical actuator to selectively move the brake rotor into braking engagement with the friction plate to inhibit linear motion of the extensible member between the retracted position and the extended position and out of braking engagement from the friction plate to freely allow linear motion of the extensible member between the retracted position and the extended position.

In accordance with aspect of the present disclosure, the method can further include configuring the electro-mechanical actuator to move the brake rotor into braking engagement with the friction plate when de-energized and to move the brake rotor out from braking engagement with the friction plate when energized.

In accordance with aspect of the present disclosure, the method can further include providing the electro-mechanical actuator as a solenoid.

In accordance with aspect of the present disclosure, the method can further include providing the solenoid having a biasing member configured to bias the brake rotor into engagement with the friction plate to establish the braking condition when the solenoid is de-energized.

In accordance with aspect of the present disclosure, the method can further include providing the solenoid having a plunger fixed to the brake rotor and an electrical winding adjacent the plunger and configuring the plunger for movement in direct response to the electrical winding being energized, wherein the brake rotor is moved out of braking engagement from the friction plate in direct response to movement of the plunger against bias of the biasing member.

In accordance with aspect of the present disclosure, the method can further include configuring a control system in electrical communication with the solenoid to selectively energize the electrical winding of the solenoid in response to receiving a signal from a sensor to establish the non-braking condition and to selectively de-energize the electrical winding of the solenoid to establish the braking condition.

These and other alternative embodiments are directed to providing an a motor-less strut having an active brake mechanism for use in a closure system of a motor vehicle and having an electro-mechanical actuator and a dual-stage planetary reduction unit integrated into a common motor-gearbox assembly to provide enhanced selective braking operation to a closure panel of the closure system in a compact arrangement.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure:

FIG. 1 is a perspective view of a motor vehicle having a closure member equipped with a pair of struts, at least one of which is provided as a motor-less strut having an active brake mechanism in accordance with the teachings of the present disclosure;

FIG. 2 is a side view of the motor-less strut having an active brake mechanism in accordance with one aspect of the present disclosure;

FIG. 2A is a cross-sectional view taken generally along the line 2A-2A of FIG. 2;

FIG. 2B is a perspective cross-sectional view of the cross-sectional view of FIG. 2A;

FIGS. 3A and 3B are perspective views of an active brake mechanism and gearbox assembly associated with the motor-less strut of FIG. 2;

FIG. 4 is a perspective view illustrating the active brake mechanism and gearbox assembly of FIGS. 3A and 3B exploded from one another;

FIG. 5 is an exploded view of the active brake mechanism and gearbox assembly of FIGS. 3A and 3B;

FIG. 6 is a perspective cross-sectional view of the active brake mechanism and gearbox assembly of FIGS. 3A and 3B;

FIG. 7A is a cross-sectional view of the active brake mechanism and gearbox assembly of FIGS. 3A and 3B shown in a brake engaged condition;

FIG. 7B is a cross-sectional view of the active brake mechanism and gearbox assembly of FIGS. 3A and 3B shown in a brake disengaged condition;

FIGS. 8 and 8A are views similar to FIGS. 2 and 2A of a motor-less strut having an active brake mechanism in accordance with another aspect of the present disclosure;

FIG. 8B is an enlarged view of the active brake mechanism of the motor-less strut of FIGS. 8 and 8A;

FIG. 9 is a system diagram including a motor-less strut and a powered strut for moving a closure panel, in accordance with an illustrative embodiment;

FIG. 10 is a flowchart illustrating a method of providing braking to pivotal movement of a closure member of a motor vehicle while in an open position, in accordance with an illustrative embodiment; and

FIG. 11 is a flowchart illustrating a method of moving a closure panel using a motor-less strut and a powered strut in accordance with an illustrative embodiment.

### DETAILED DESCRIPTION OF EXAMPLE EMBODIMENTS

Vehicles, particularly passenger vehicles, are equipped with numerous moveable closure panels for providing openings and access within and through defined portions of the vehicle body. To enhance operator convenience, many vehicles are now equipped with dampeners, such as gas struts, as well as power-operated closure systems to automatically regulate and control movement of all types of closure panels including, without limitation, hatch lift gates, trunk and hood deck lids, sliding and hinged doors, sun roofs and the like. The regulated and controlled movement and powered mechanical advantage is often provided by an electromechanical brake system and drive device assembly, including without limitation, motor-driven gear drives, cable drives, chain drives, belt drives and power screw drives. Current development focus is largely directed to improving these popular systems through weight and part count reduction, reduced packaging size and efficiency, reduced system noise, reduced drive effort, reduced cost and improved ease of assembly and service repair. Accordingly, the present disclosure addresses all of these and additional issues as will be readily appreciated and understood by one possessing ordinary skill in the art of this disclosure.

For purposes of descriptive clarity, the present disclosure is described herein in the context of one or more specific vehicular applications, namely lift gate and deck lid systems. However, upon reading the following detailed description in conjunction with the appended drawings, it will be clear that the inventive concepts of the present disclosure can be applied to numerous other systems and applications. In this regard, the present disclosure is generally directed to motor-less electromechanical counterbalance struts equipped with an electro-mechanical brake mechanism comprised of an actuation coupler/decoupler (rotor and friction plate) coupled with a geared reduction unit, and a rotary-to-linear motion conversion assembly regulated for selective movement by the electro-mechanical brake mechanism and the geared reduction unit. In addition, the present disclosure is directed to the geared reduction unit being equipped with a dual-stage planetary geartrain which advances the art and provides improvements over conventional geared reduction units. More specifically, the dual-stage planetary geartrain is configured to include a first stage planetary gearset and a second stage planetary gearset each associated with a common ring gear to bolster the frictional resistance through the system during a braking condition, as will be readily understood by one possessing ordinary skill in the art upon view the entirety of the disclosure herein.

In the following description, details are set forth to provide an understanding of the present disclosure. In some instances, certain controls, control systems, circuits, structures and techniques have not been described or shown in detail in order not to obscure the disclosure, as they will be readily understood by one possessing ordinary skill in the art in view of the disclosure herein.

In general, the present disclosure relates to a motor-less brake and gearbox assembly of the type discovered to be well-suited for use in many vehicular closure member (closure panel) applications. The motor-less brake and gearbox assembly and associated methods of construction and operation of this disclosure will be described in conjunction with one or more non-limiting example embodiments. It is to be understood that the specific example embodiments disclosed are merely provided to describe the inventive aspects and contributions to the art, including features, advantages and objectives, with sufficient clarity to permit those skilled in the art of vehicle closure panel brake mechanisms to understand and practice the disclosure. Specifically, the example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

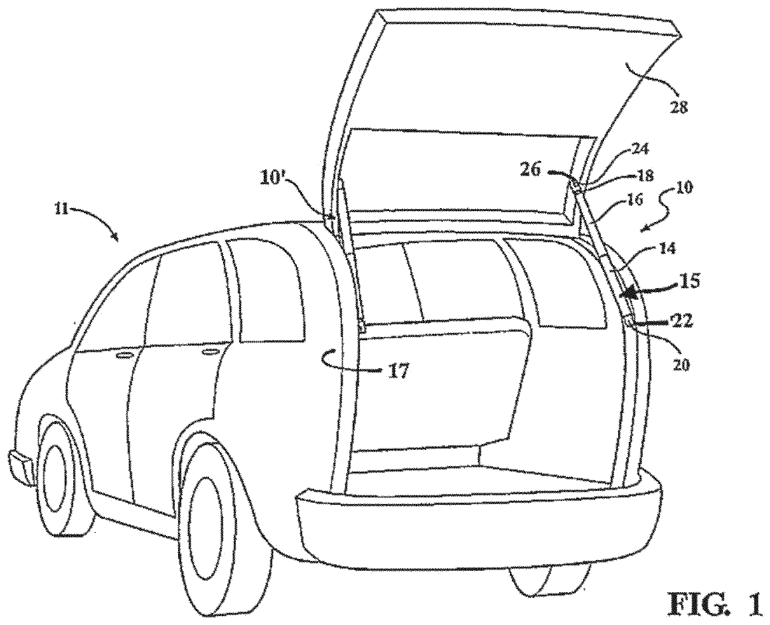

Referring now to FIG. 1, a motor vehicle 11 having at least one embodiment of a motor-less counterbalance strut, referred to hereafter as strut 10, is shown mounted thereto, wherein the vehicle 11 may have a plurality of the struts 10, and further, may include a power-actuated electro-mechanical strut 10′ without a brake, if desired to facilitate powered movement of a closure panel 28 between open and closed positions relative to a vehicle body 17 of motor vehicle 11. As such, it is to be recognized that one or more of the struts 10 can be used in a manually operated closure member arrangement or in a power-actuated closure member arrangement, as will be understood in view of the present disclosure. Strut 10 includes a brake assembly 12 and gearbox unit, also referred to as gearbox assembly 13, forming a brake and gearbox assembly 15, enveloped in an upper outer housing or tube, referred to hereafter simply as housing 14, and an extensible member, also referred to as telescoping unit 16, enveloped in an outer lower housing or tube, referred to hereafter simply as extensible tube 18. A first pivot mount 20, such as a 10 mm ball stud, by way of example and without limitation, fixed to a first end 22 of the strut 10, is pivotally mounted to a portion of the vehicle body 17 adjacent an interior cargo area in the vehicle 11. A second pivot mount 24, such as a 10 mm ball stud, by way of example and without limitation, fixed to a second end 26 of the strut 10, is pivotally mounted to the closure member, shown as a lift gate 28, of the vehicle 11, by way of example and without limitation. Extensible member 16 is movable between a retracted position, corresponding to a closed position of lift gate 28, and an extended position, corresponding to an open position of the lift gate 28.

Strut 10 comprises the two main units: the brake and gearbox assembly 15 and the telescoping unit 16. Brake and gearbox assembly 15 can be sized and rated to function with a variety of shapes and sizes of closure panels associated with different vehicles. Telescoping unit 16 may be sized as required for each unique vehicle model to achieve a desired telescoping travel length. Gearbox assembly 13 is operably coupled to telescoping unit 16, and can include a sprag 25 at an output end (axially spaced from brake assembly 12), with sprag 25 being configured for rotatable engagement with an elastomeric flex coupling 27, which in turn is configured for rotatable engagement with an adaptor 29. Adaptor 29 is coupled for conjoint rotation with a rotary drive member, shown as a leadscrew 30, of telescoping unit 16.

Telescoping unit 16 comprises outer extensible tube, also referred to as guide tube or tubular casing 18 and an inner tubular nut-shaft 32, which are rigidly fixed to one another via an end cap 33 with an annular, toroidal chamber 34 defined therebetween. One end of toroidal chamber 34 is closed off by end cap 33 and an opposing end of toroidal chamber 34 remains open, as shown. Tubular nut-shaft 32 further defines a hollow cylindrical chamber 36 radially inward of toroidal chamber 34.

A driven member, also referred to as driven nut or nut 38, is fixedly mounted to nut-shaft 32 in cylindrical chamber 36 of tubular nut-shaft 32 proximate opening thereof. Nut 38 can be fixed to tubular nut-shaft 32 via any desired mechanism, including adhesive, weld joint, and/or mechanical fasteners, such as a rivet, by way of example and without limitation. Nut 38 is threadedly coupled with leadscrew 30 in order to convert the rotational movement of leadscrew 30 into axially linear translation motion of extensible member 16 along a longitudinal axis A of leadscrew 30.

A power spring, also referred to as dampening spring 40, is disposed and seated within toroidal chamber 34 and within a toroidal chamber 42 defined between a stationary inner guide tube 44 and housing 14. Power spring 40 is a coil spring that uncoils (extends axially) and recoils (compresses axially) as extensible member 16 moves relative to stationary inner guide tube 44 and housing 14. The annular spacing between stationary inner guide tube 44 and housing 14 is sized to closely fit the preferred toroidal form of power spring 40, wherein power spring 40 can be formed of coiled spring metal or wire having any desired diameter and length. One end 46 of power spring 40 abuts, and can be fixedly connected to end cap 33 of extensible member 16, and another end 48 of power spring 40 abuts, and can be fixedly connected to an end 50 of stationary inner guide tube 44 that is proximate to, and ultimately supported by, brake and gearbox assembly 15. It should be appreciated that in the present embodiment, power spring 40 is guided and supported against buckling along its entire length of travel by the combined action of stationary inner guide tube 44 which guides the inside edge or surface of power spring 40, and outer housing 14 which guides the outer edge or surface of power spring 40. In the preferred embodiment, when extensible member 16 is at its fully extended position, stationary inner guide tube 44 and extensible tube 18 overlap or are co-extensive with one another, thus inhibiting the tendency of power spring 40 to buckle.

Power spring 40 provides a mechanical counterbalance to the weight of lift gate 28. Power spring 40 may assist in raising the lift gate both in a powered and un-powered modes. When extensible member 16 is in the retracted position, power spring 40 is tightly compressed between end cap 33 of extensible member 16 and end 50 of inner guide tube 44. As leadscrew 30 rotates to extend extensible member 16, power spring 40 extends as well, releasing its compressed, stored energy and transmitting an axial force through extensible member 16 to help raise lift gate 28. When leadscrew 30 rotates to compress and retract extensible member 16, such as when lift gate 28 is manually or powered closed, power spring 40 is compressed axially between end cap 33 and the end 50 of inner guide tube 44, and thus, spring energy is restored within power spring 40.

It is appreciated and contemplated herein that a ball screw assembly, as known in the art, could be used in lieu of nut 38. Also, although reference has been made specifically to a lift gate, it is also appreciated that the aspects of the disclosure may be applied to a variety of other closure panels, such as trunks or deck lids, for example.

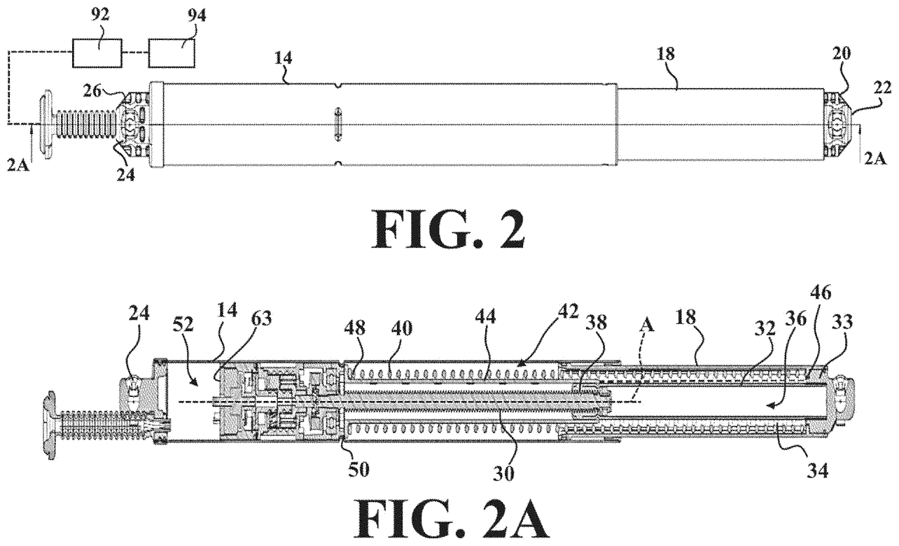

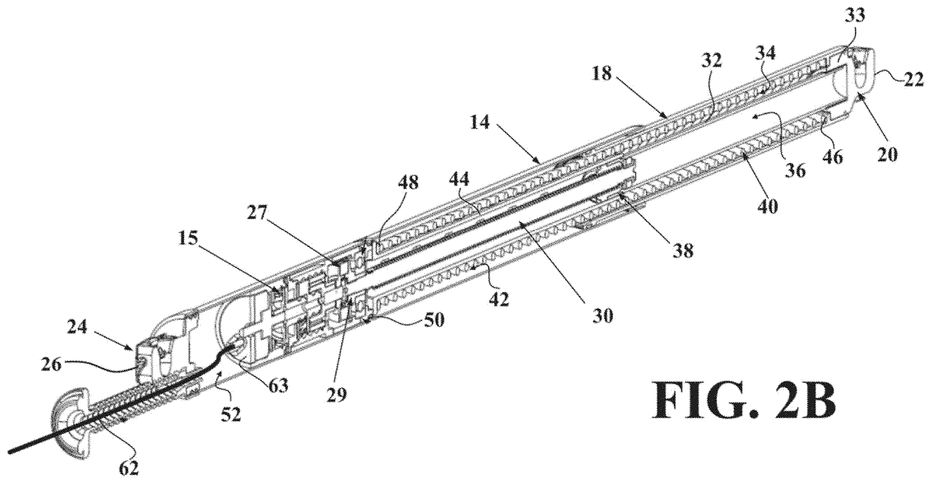

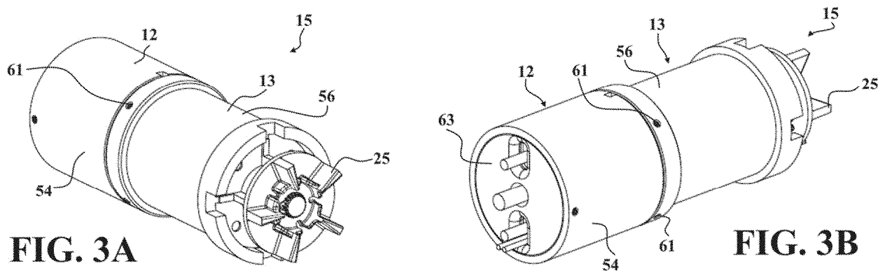

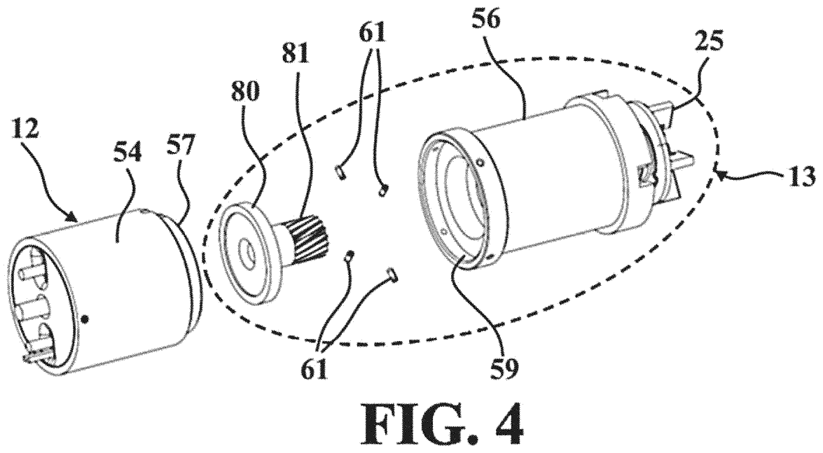

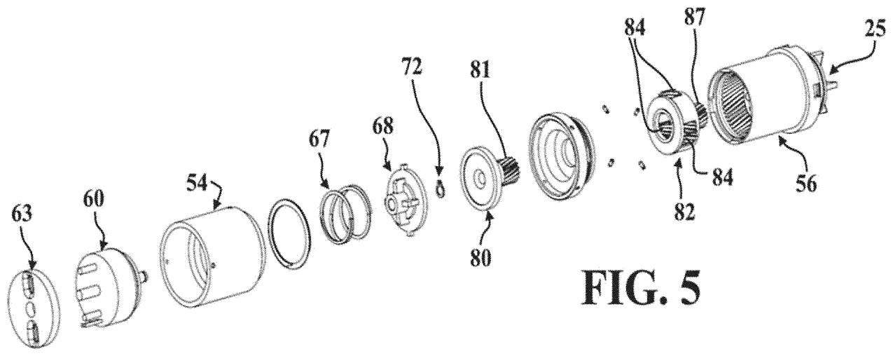

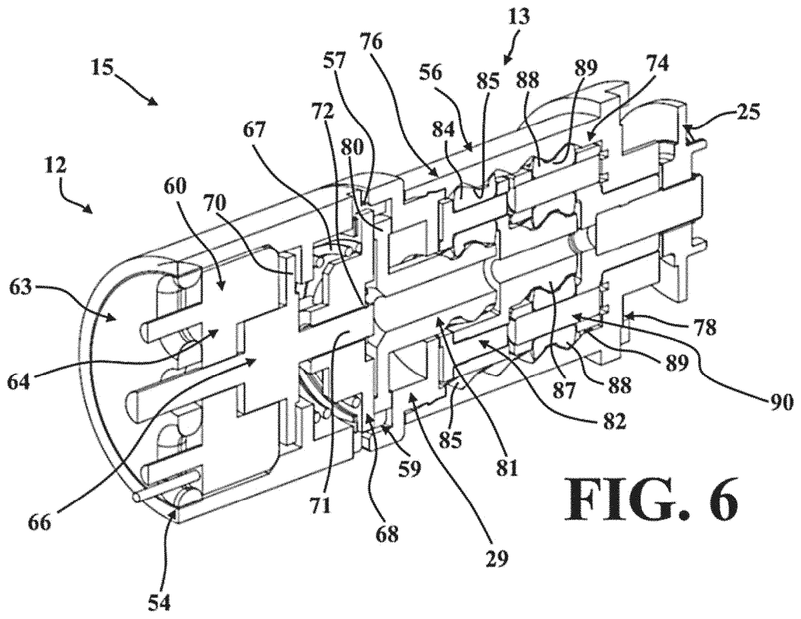

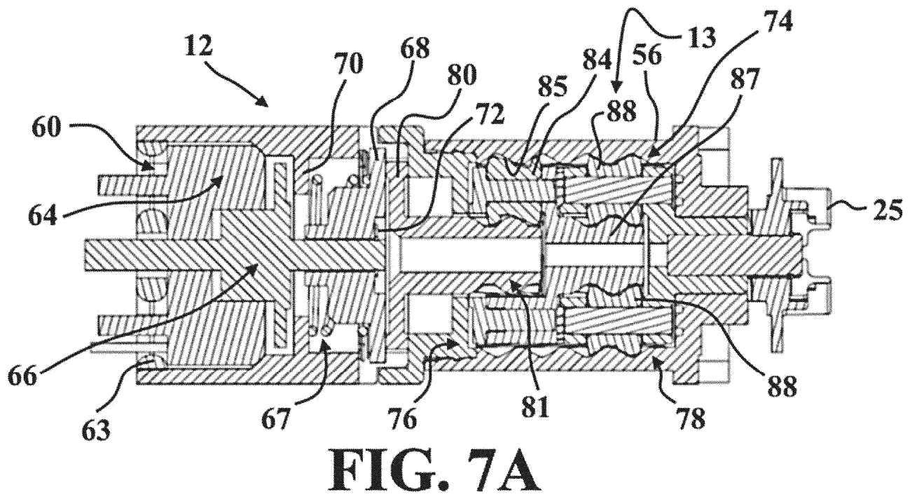

As shown in FIGS. 2A and 2B, in accordance with one embodiment of strut 10 constructed in accordance with the present disclosure, brake and gearbox assembly 15 can be configured to be installed within a chamber 52 of tubular housing 14. Brake and gearbox assembly 15 is generally a two unit assembly configured to integrate brake assembly 12 and a gearbox assembly 13 into a common assembly via interconnection of a brake housing 54 with a gearbox housing, provided as an outer ring gear 56. The interconnection can be made via any suitable adhesive, weld joint and/or mechanical fastening mechanism, as desired, shown, by way of example and without limitation, as having a reduced diameter end 57 of brake housing 54 being disposed within an enlarged counterbore 59 of ring gear 56, with fasteners 61 dispersed about a periphery of counterbore 59.

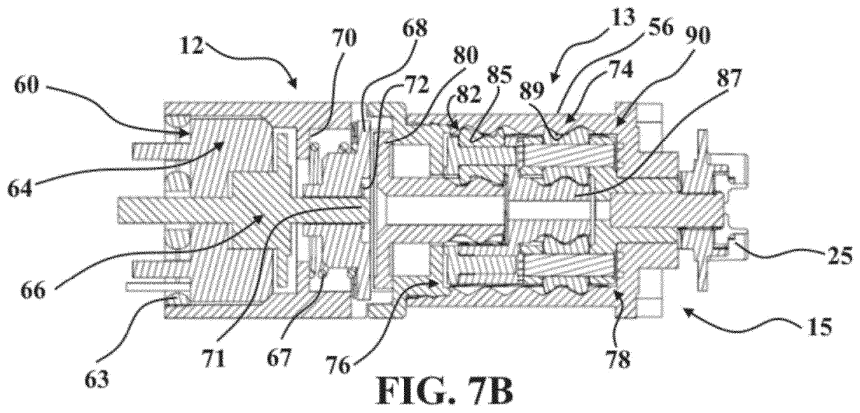

Brake assembly 12 includes an electro-mechanical actuator, shown as a solenoid 60, by way of example and without limitation. Solenoid 60 is powered via an electrical wire harness 62 via any suitable power source, such as via battery (not shown). Solenoid 60 is disposed in brake housing 54 and concealed therein via an end cover 63. Solenoid 60 has a solenoid body 64 containing electrical windings, as known, that can be de-energized to effect axially linear movement of a solenoid plunger, referred to hereafter as plunger 66 to an axially extended, brake disengaged position (FIG. 7A) and energized to effect axially linear movement of the plunger 66 to an extended, brake engaged position (FIG. 7B). Solenoid 60 is illustratively configured as a pull type solenoid. To facilitate movement of the plunger 66 to the extended, brake engaged state while solenoid 60 is de-energized, a bias member, shown as a coil spring 67, by way of example and without limitation, is disposed between an enlarged, disc-shaped brake rotor 68 and a flange 70 extending radially inwardly from brake housing 54. Spring 67 is shown as extending about a generally cylindrical outer surface of rotor 68, and thus, spring 67 can be provided having a relatively large outer surface diameter, approximating that of an inner surface diameter of housing 54. As such, spring 67 can be provided having a wide range of spring forces, as desired, thereby providing enhanced design options, thereby reducing overall cost. Brake rotor 68 is shown fixedly coupled directly to an end of a shaft 71 of plunger 66, such as via any suitable adhesive, weld joint, and/or mechanical fastener, shown as a clip or snap ring 72, by way of example and without limitation. Accordingly, brake rotor 68 is configured to move axially and conjointly with plunger 66 as plunger 66 moves in response to energization of solenoid 60 to the brake disengaged state (FIG. 7B) and the de-energization of solenoid 60 to the brake engaged state (FIG. 7A). With the plunger 66 being fixed to brake rotor 68, and the electromagnetic attraction of electrical winding(s) within solenoid body 64 acting directly on plunger 66, the brake rotor 68 is caused to remain stable as it moves with plunger 66 between the engaged and disengaged states. Accordingly, brake rotor 68 is able to remain free of wobble or misalignment relative to axis A, thereby promoting reliable, predictable and consistent movement of brake rotor 68, and thus, enhancing the operating efficiency of brake assembly 12, such as compared to that if the brake rotor were floating and acted on directly by electromagnetic waves. The plunger 66 is positioned along the axis A of the solenoid 60, also provided co-axial with longitudinal axis A of leadscrew 30, and surrounded by the solenoid body 64 containing the electrical windings or coils such that the plunger 66 is subjected to the maximum inductance from the electrical windings as is possible providing a high pull force to weight/power consumption ratio as compared to an electromagnet generating electromagnet fields outside an end of the electromagnet. Solenoid 60 may be configured as slideably supporting the plunger 66 for axial displacement along axis A, and consequentially the brake rotor 68, and having alternatively a spring internally provided for urging the plunger 66 away from the interior of the solenoid body 64 and into the brake engaged state, thereby providing a compact integral unit of the brake assembly 12.

Gearbox assembly 13 is shown to include the gearbox housing, shown configured as the ring gear 56, and a plurality of gear members providing a dual-stage planetary geartrain 74 disposed therein. Dual stage planetary geartrain 74, aside from ring gear 56, which functions as a “common” ring gear, as discussed further hereafter, includes a first stage gearset 76 and a second stage gearset 78. The second stage gearset 78 is driven by a rotary output of the rotary drive member (leadscrew 30) and the first stage gearset 76 is driven by the second stage gearset 78. The first stage gearset 76 includes, and is shown fixed to a friction plate 80, which is configured for operable communication with the brake rotor 68 of the active brake assembly, also referred to as brake mechanism 12. The electro-mechanical actuator 60 is configured to allow the brake rotor 68 to move into frictional braking engagement with the friction plate 80 to inhibit linear motion of the extensible member 16 between the retracted position and the extended position. The electro-mechanical actuator 60 is also configured to selectively move the brake rotor 68 out of frictional braking engagement from the friction plate 80 to freely allow linear motion of the extensible member 16 between the retracted position and the extended position, as desired during a closure panel opening and closing event.

The first stage gearset 76 of the dual-stage planetary geartrain 74 includes a first sun gear 81 (also referred to as first pinion gear or pinion), a first stage planetary assembly 82 including a first planet carrier having a plurality of first pins, and a plurality of first planet gears 84 each being rotatably supported on one of the first pins and in constant meshed engagement with the first sun gear 81 and a first ring gear segment 85 of the common ring gear 56. The second stage gearset 78 of the dual-stage planetary geartrain 74 includes a second sun gear 87 (also referred to as second pinion gear or pinion), a second stage planetary assembly 90 including a second planet carrier having a plurality of second pins rotatably driven by the rotary output of the rotary drive member 30, and a plurality of second planet gears 88 each being rotatably supported on one of the second pins and in constant meshed engagement with the second sun gear 87 and a second ring gear segment 89 of the common ring gear 56. The second planet gears 88 rotatably drive the second sun gear 87, which in turn rotatably drives the first planet carrier and first planet gears 84. The first planet gears 84 rotatably drive the first sun gear 81, which is fixed to the friction plate 80. The friction plate 80 is configured to be axially spaced from, and out of contact with, the brake rotor 68 in a non-braking condition (solenoid 60 energized, FIG. 7B) to allow the aforementioned relative rotation between the first and second planet gears 84, 88, the first and second sun gears 81, 87 and the first and second ring gear segments 85, 89 to allow free pivotal movement of the closure member 28 between open and closed positions.

Based on the arrangement disclosed, first stage gearset 76 is configured to provide a first speed reduction and first friction multiplication between motor brake rotor 68 and the friction plate 80 fixed to first sun gear 81 (e.g. output). Furthermore, second stage gearset 78 is configured to provide a second speed reduction and second friction multiplication between first stage planetary assembly 82 and second stage planetary assembly 90. Thus, a dual-stage speed reduction and friction multiplication ratio drive connection is established across gearbox assembly 13.

In accordance with one preferred construction for dual-stage planetary geartrain 74 it is contemplated that first ring gear segment 85 and second ring gear segment 89 of common ring gear 56 have the identical diameter and tooth pattern for providing commonality between both of first stage gearset 76 and second stage gearset 78, thereby permitting simplified manufacture, reduced noise and optimized alignment of the geared components within gearbox housing 56. In addition, the use of commonly-aligned and sized first pins and second pins, in combination with uniform first and second ring gear segments of ring gear 56, permits use of the same satellite (planet) gears and similarly-sized sun gears for first stage gearset 76 and second stage gearset 78. The tooth pattern of common ring gear 56 is shown to be a continuous helical gear tooth pattern associated with first ring gear segment 85 and second ring gear segment 89. As such, helical gear teeth are also formed on the first and second planet gears 84, 88 as well as the first and second sun gears 81, 87. However, the present disclosure is intended to also include the optional use of straight toothed (i.e. spur gear) gear components for dual-stage planetary geartrain 74.

To reduce weight, it is contemplated that first planet carrier and/or second planet carrier can be formed from rigid plastic materials or lightweight metal, such as aluminum. Likewise, gearbox housing and its integrally-formed common ring gear 56 can also be made from plastic. Gearbox housing 56 preferably has a common outer diameter along its entire length. It is also contemplated that equal numbers of first and second planet gears may be used for dual-stage planetary geartrain 74, that common planet carriers may be used, and that single ring-type carriers or dual ring-type carriers can be used. Furthermore, different materials for the planet carriers and/or the pins can be used to accommodate torque requirements such as, for example, plastic components associated with first stage planetary assembly 82 and metal components associated with second stage planetary assembly 90. The use of such components permits a modular design approach and accommodate varying strength requirements while maintaining common gear component sizes for interchangeability.

In a preferred arrangement, the combination of teeth number associated with common ring gear 56 and first sun gear 81 and second sun gear 87 (also referred to as input) are selected to permit first stage planetary assembly 82 to include a plurality of three (3) first planet gears 84 and second stage planetary assembly 90 to include a plurality of four (4) second planet gears 88 to provide the desired overall speed reduction and friction multiplication while providing a very compact geartrain arrangement. However, dual-stage planetary geartrain 74 can also be configured to use differently sized planet gears and sun gears to establish differing speed ratio reductions between first stage planetary assembly 82 and second stage planetary assembly 90 in conjunction with common ring gear 56. Accordingly, the present disclosure contemplates use of helical gearing in both stages of a dual-stage planetary geartrain; similarly sized pins associated with the planet carriers; use of commonly sized helical planet and sun gears; use of differing materials to meet strength and noise requirements; and provide a modular approach to motor-gearbox assemblies.

In addition to the above, the following is a summary of some advantageous features associated with the dual-stage planetary geartrain 74. The use of a planetary gearbox having a common ring gear 56 (continuous interior of same diameter and continuous tooth pattern) for use with first and second stage planetary assemblies 82, 90 provides ease of manufacture, reduced noise and improved gear alignment. Additionally, the use of the same size pins in combination with common ring gear 56 allows for common planet gears 84, 88 to be used in both the first and second stage planetary assemblies 82, 90. Different materials can be used for pins to accommodate loading in both the first and second stage planetary assemblies 82, 90, such as, for example, using plastic pins in the first stage planetary assembly 82 and metal pins in second stage planetary assembly 90. Differing types of planet carriers (single carrier plate, dual carrier plates) and/or integration of both planet carriers into a common unit are also possible contemplated alternatives. Additionally, such an integrated carrier unit can be molded together with the planet gears and the pins (for example, compression molding or injection molding of plastics or powdered metals. Other features may include use of plastic planet carriers in combination with metallic pins to reduce overall mass while providing low-friction high-strength axes for the planet gear rotation. Finally, the ability to use differing number of planet gears 84, 88 for first stage planetary assembly 82 and second stage planetary assembly 90 in combination with common ring gear 56 provides enhanced load capabilities, non-equivalent ratio reductions and easier assembly.

In use, the dual-stage planetary geartrain 74 of the gearbox unit 13 is configured such that the second stage gearset 78 is driven directly by a rotary output of a rotary-to-linear mechanism 16 and the first stage gearset 76 is driven directly by the second stage gearset 78. The first stage gearset 76 is configured for operable communication with the brake rotor 68, with the dual-stage planetary geartrain 74 providing a torque and friction multiplication and speed reduction function between the rotary output of the telescoping unit (also referred to as rotary-to-linear actuator 16) and the brake rotor 68 to enhance the braking efficacy of the brake rotor 68 when selectively brought into operable contact with the friction plate 80 fixed to first stage gearset 76. It has been found that greater than 200N of linear brake force can be attained when the counterbalance brake assembly 12 is engaged while solenoid 60 is de-energized. It is to be recognized that spring 67 imparts sufficient force on brake rotor 68 to maintain brake rotor 68 in frictional engagement with friction plate 80 to effect such braking force; however, if desired, the user can exert enough force on closure panel 28 to overcome the braking resistance between brake rotor 68 and friction plate 80. In contrast, the brake force has been found to be reduced to less than 50N of linear braking force when the counterbalance brake assembly 12 is disengaged while solenoid 60 is energized, thereby allowing significantly less effort to move the closure panel 28 between open and closed positions. It is to be recognized that the spring bias exerted by spring 67 is overcome during selective actuation of solenoid 60 such that axially driven movement of plunger 66 via magnetic pull by energized windings of solenoid 60 causes conjoint movement the brake rotor 68 axially out from frictional engagement with friction plate 80, whereupon de-energization of solenoid 60 then allows spring 67 to return brake rotor 68 into frictional engagement with friction plate 80 under the un-attenuated spring bias of spring 67. Accordingly, the default, de-energized position of strut 10 is in the brake engaged position (FIG. 7A).

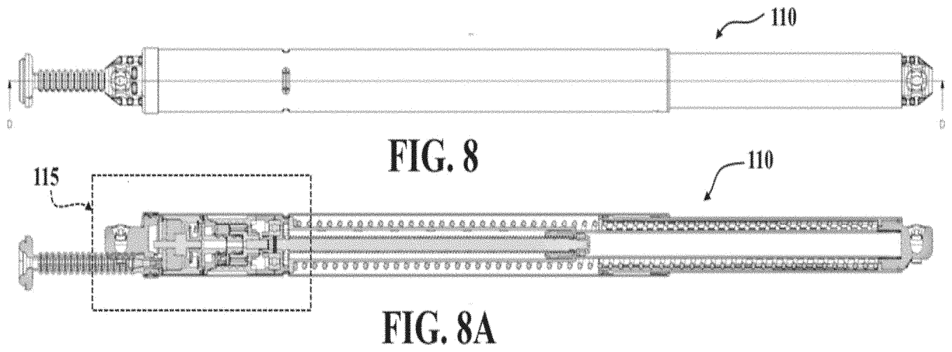

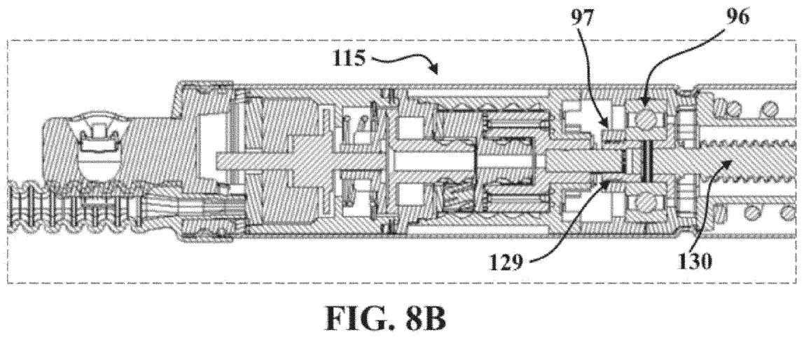

In FIGS. 8-8B, a motor-less strut 110 constructed in accordance with another aspect of the disclosure is illustrated, wherein the same reference numerals, offset by a factor of 100, are used to identify like features. Motor-less strut 110 is similar to motor-less strut 10, with notable differences being directed to a brake and gearbox assembly 115 thereof (FIG. 8B). The brake and gearbox assembly 115 includes a roller bearing 96 with nut 97 fixing roller bearing against axial movement, wherein roller bearing 96 supports leadscrew 130 for reduced friction rotation. Further, the flex coupling 27 of strut 10 has been removed, and the adaptor 129 has been modified, as shown. Ultimately, the modifications reduce the functional length of strut 110, thereby enhancing the packaging options in assembly. Otherwise, strut 110 functions similarly to strut 10, and thus, no further discussion is believed necessary.

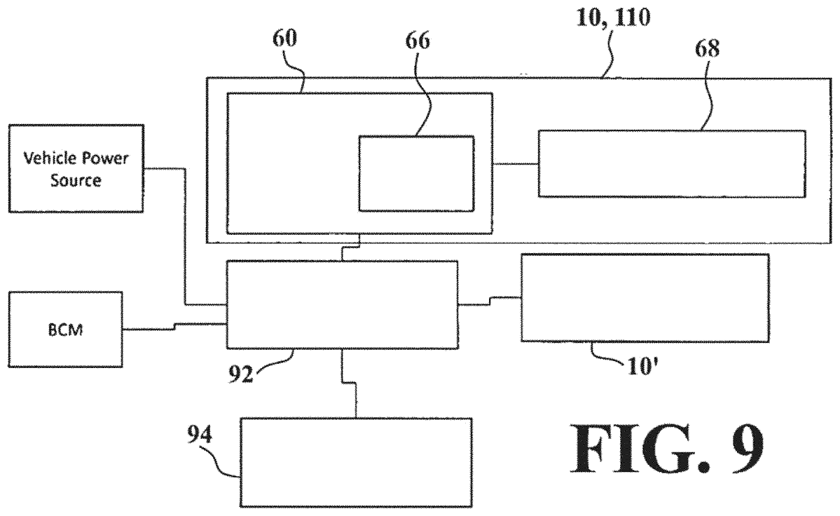

With reference to FIG. 1 and FIG. 9, the motor-less counterbalance strut 10, 110 is shown in electrical communication with a control system 92 e.g. control system 92 is in electrical communication with the electro-mechanical actuator 60 to selectively energize the electro-mechanical actuator 60, such as with an ON/OFF application of current through the coils, or a variable pulse application of current (e.g. PWM signal to solenoid coils), in response to receiving a signal from a sensor 94 e.g. a linear sensor, hall sensor, accelerometer, or other type of sensor provided on the motor less counterbalance strut 10, 110 to detect, as an example, the motion of the extensible member 18, or as a accelerometer provided on the closure panel 28 to detect a motion, or manual user control thereof, in order to establish the non-braking condition and to selectively de-energize the electro-mechanical actuator 60 to establish the braking condition. Control system 92 may also be configured to power an actuator of the powered strut 10′, in conjunction with controlling the brake of motor-less counterbalance strut 10, 110 in response for example to a detection of a motion of the closure panel 12 indicating a user's intent to initiate a power assisted move the closure panel 12, or in response to a command signal from a vehicle control system, such as a Body Control Module receiving a command signal from a vehicle wireless key FOB 99, to power the power strut 10′ to move the closure panel 12 between an open and closed position. Control system 92 may be configured to de-energize power strut 10′ and energize the brake of motor-less counterbalance strut 10, 110 in response for example to a detection of a holding force or stopping of the closure panel 12 indicating a user's intent to apply the brake to the closure panel 12 at the specified position the user relinquishes control e.g. ceases to apply a closing or opening force on the closure panel 12.

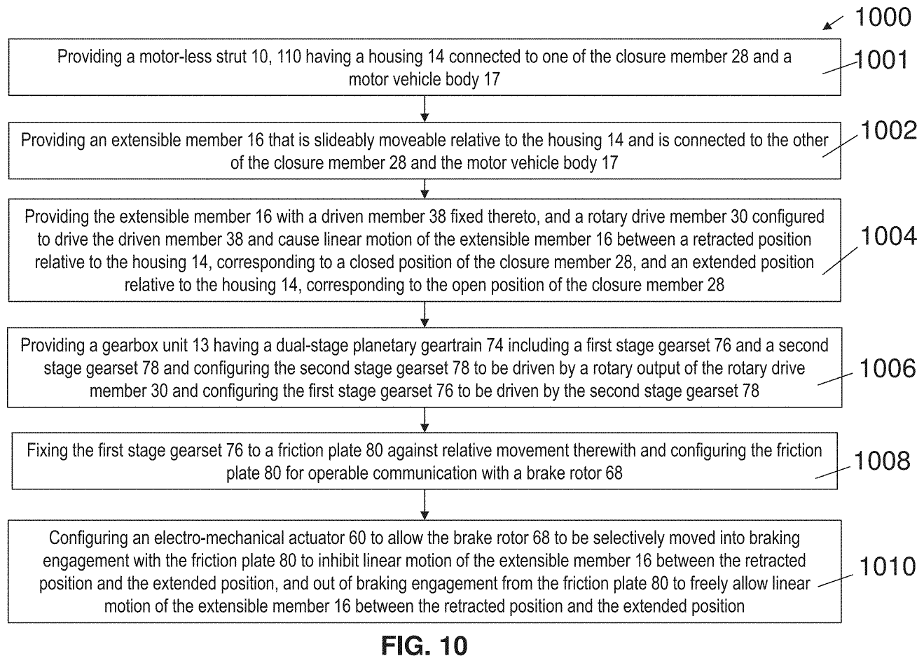

In accordance with a further aspect of the disclosure, with reference to FIG. 10, a method 1000 of providing braking to pivotal movement of a closure member 28 of a motor vehicle 11 while in an open position is provided. The method 1000 includes a step 1001 of providing a motor-less strut 10, 110 having a housing 14 connected to one of the closure member 28 and a motor vehicle body 17. Further, a step 1002 of providing an extensible member 16 that is slideably moveable relative to the housing 14 and is connected to the other of the closure member 28 and the motor vehicle body 17. Further yet, a step 1004 of providing the extensible member 16 with a driven member 38 fixed thereto, and a rotary drive member 30 configured to drive the driven member 38 and cause linear motion of the extensible member 16 between a retracted position relative to the housing 14, corresponding to a closed position of the closure member 28, and an extended position relative to the housing 14, corresponding to the open position of the closure member 28. The method further including a step 1006 of providing a gearbox unit 13 having a dual-stage planetary geartrain 74 including a first stage gearset 76 and a second stage gearset 78 and configuring the second stage gearset 78 to be driven by a rotary output of the rotary drive member 30 and configuring the first stage gearset 76 to be driven by the second stage gearset 78. Further, the method includes a step 1008 of fixing the first stage gearset 76 to a friction plate 80 against relative movement therewith and configuring the friction plate 80 for operable communication with a brake rotor 68. Additionally, a step 1010 includes configuring an electro-mechanical actuator 60 to allow the brake rotor 68 to be selectively moved, shown as being axially biased in a first axial direction via a spring member 67, by way of example and without limitation, into braking engagement with the friction plate 80 to inhibit linear motion of the extensible member 16 between the retracted position and the extended position, and to allow the brake rotor 68 to be selectively moved in a second axial direction out of braking engagement from the friction plate 80, such as under a pulling bias of the brake friction plate 80 against the bias of the spring member 67 via energization of the electro-mechanical actuator 60, to freely allow linear motion of the extensible member 16 between the retracted position and the extended position.

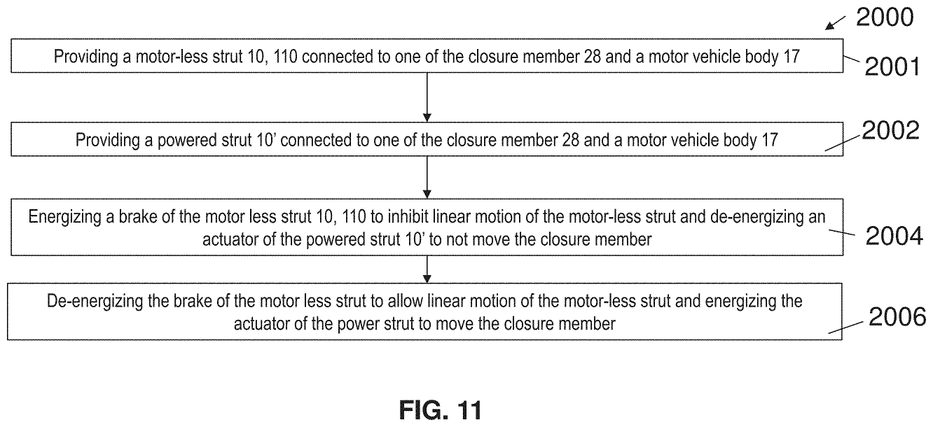

With reference to FIG. 11, there is provided a method 2000 of moving a closure panel using the motor-less counterbalance strut 10, 110 and a powered strut 10′ including the steps of providing 2001 a motor-less strut 10, 110 connected to one of the closure member 28 and a motor vehicle body 17, providing 2002 a powered strut 10′ connected to one of the closure member 28 and a motor vehicle body 17, energizing 2002 a brake of the motor less strut 10, 110 to inhibit linear motion of the motor-less strut and de-energizing an actuator of the powered strut 10′ to not move the closure member, and de-energizing 2006 the brake of the motor less strut to allow linear motion of the motor-less strut and energizing the actuator of the power strut to move the closure member.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Those skilled in the art will recognize that concepts disclosed in association with the example detection system can likewise be implemented into many other systems to control one or more operations and/or functions.

What is claimed is:

1. A motor-less counterbalance strut for selectively braking movement of a pivotal closure member from an open position toward a close position, comprising:
a housing connected to one of the closure member and a motor vehicle body;
an extensible member connected to the other of the closure member and the motor vehicle body and having a driven member fixed thereto, wherein a rotary drive member is configured to drive the driven member and cause linear motion of the extensible member relative to the housing between a retracted position, corresponding to the closed position of the closure member, and an extended position, corresponding to the open position of the closure member;
a gearbox unit including an input configured for driven movement by a rotary output of the rotary drive member and an output configured for driven movement in response to the driven movement of the input, the output being fixed to a friction plate configured for operable communication with a brake rotor, the gearbox unit providing a torque and friction multiplication and speed reduction function between the input and the output; and
an electro-mechanical actuator configured to move the brake rotor into braking engagement with the friction plate to establish a braking condition to inhibit linear motion of the extensible member between the retracted position and the extended position and to move the brake rotor out of braking engagement from the friction plate to establish a non-braking condition to allow linear motion of the extensible member between the retracted position and the extended position.

2. The motor-less counterbalance strut of claim 1, wherein the electro-mechanical actuator is configured to move the brake rotor into braking engagement with the friction plate when de-energized and to move the brake rotor out from braking engagement with the friction plate when energized.

3. The motor-less counterbalance strut of claim 2, wherein a linear braking force greater than 200N is established when the electro-mechanical actuator is de-energized and a linear braking force less than 50N is established when the electro-mechanical actuator is energized.

4. The motor-less counterbalance strut of claim 1, wherein the electro-mechanical actuator is a solenoid.

5. The motor-less counterbalance strut of claim 4, further including a biasing member configured to bias the brake rotor into engagement with the friction plate to establish the braking condition when the electro-mechanical actuator is de-energized.

6. The motor-less counterbalance strut of claim 5, wherein the solenoid has a plunger fixed to the brake rotor and an electrical winding adjacent the plunger, the plunger being configured for movement in direct response to the electrical winding being energized, wherein the brake rotor is moved out of braking engagement from the friction plate in direct response to movement of the plunger against bias of the biasing member.

7. The motor-less counterbalance strut of claim 1, further including a control system in electrical communication with the electro-mechanical actuator to selectively energize the electro-mechanical actuator in response to receiving a signal from a sensor to establish the non-braking condition and to selectively de-energize the electro-mechanical actuator to establish the braking condition.

8. The motor-less counterbalance strut of claim 1, wherein the gearbox unit includes a dual-stage planetary geartrain including a first stage gearset and a second stage gearset, the second stage gearset being configured to be driven by a rotary output of the rotary drive member and the first stage gearset being configured to be driven by the second stage gearset and being fixed to the friction plate, wherein the gearbox unit includes a common ring gear, a first sun gear, a first stage planetary assembly including a plurality of first planet gears each being in constant meshed engagement with the first sun gear and a first ring gear segment of the common ring gear.

9. The motor-less counterbalance strut of claim 8, wherein the gearbox unit includes a second sun gear, a second stage planetary assembly including a plurality of second planet gears each being in constant meshed engagement with the second sun gear and a second ring gear segment of the common ring gear.

10. The motor-less counterbalance strut of claim 9, wherein the first ring gear segment and the second ring gear segment of the common ring gear define a continuous helical gear tooth pattern in meshed engagement with the helical first planet gears and the helical second planet gears.

11. A method of providing braking to pivotal movement of a closure member of a motor vehicle while in an open position, comprising:
providing a motor-less strut having a housing connected to one of the closure member and a motor vehicle body;
providing an extensible member that is slideably moveable relative to the housing and is connected to the other of the closure member and the motor vehicle body;
providing the extensible member with a driven member fixed thereto, and a rotary drive member configured to drive the driven member and cause linear motion of the extensible member between a retracted position relative to the housing, corresponding to a closed position of the closure member, and an extended position relative to the housing, corresponding to the open position of the closure member;
providing a gearbox unit having a dual-stage planetary geartrain including a first stage gearset and a second stage gearset and configuring the second stage gearset to be driven by a rotary output of the rotary drive member and configuring the first stage gearset to be driven by the second stage gearset;
fixing the first stage gearset to a friction plate, and configuring the friction plate for operable communication with a brake rotor; and
configuring an electro-mechanical actuator to selectively move the brake rotor into braking engagement with the friction plate to inhibit linear motion of the extensible member between the retracted position and the extended position and out of braking engagement from the friction plate to freely allow linear motion of the extensible member between the retracted position and the extended position.

12. The method of claim 11, further including configuring the electro-mechanical actuator to move the brake rotor into braking engagement with the friction plate when de-energized and to move the brake rotor out from braking engagement with the friction plate when energized.

13. The method of claim 12, further including providing the electro-mechanical actuator as a solenoid.

14. The method of claim 13, further including providing the solenoid having a biasing member configured to bias the brake rotor into engagement with the friction plate to establish the braking engagement when the solenoid is de-energized.

15. The method of claim 14, further including providing the solenoid having a plunger fixed to the brake rotor and an electrical winding adjacent the plunger and configuring the plunger for movement in direct response to the electrical winding being energized, wherein the brake rotor is moved out of braking engagement from the friction plate in direct response to movement of the plunger against bias of the biasing member.

16. The method of claim 15, further including configuring a control system in electrical communication with the solenoid to selectively energize the electrical winding of the solenoid in response to receiving a signal from a sensor to establish the out of braking engagement and to selectively de-energize the electrical winding of the solenoid to establish the braking condition.

17. A closure panel system for a closure panel of a motor vehicle, comprising:
a powered strut having a motor to facilitate moving the closure panel between open and closed positions; and
a motor-less counterbalance strut, including:
a housing connected to one of the closure panel and a motor vehicle body;
an extensible member slideably moveable relative to the housing and connected to the other of the closure member and the motor vehicle body, the extensible member having a driven member fixed thereto, wherein a rotary drive member is configured to drive the driven member and cause linear motion of the extensible member between a retracted position relative to the housing, corresponding to a closed position of the closure member, and an extended position relative to the housing, corresponding to the open position of the closure member;
a gearbox unit provided having a dual-stage planetary geartrain including a first stage gearset and a second stage gearset, the second stage gearset being configured to be driven by a rotary output of the rotary drive member and the first stage gearset being configured to be driven by the second stage gearset, the first stage gearset being fixed to a friction plate configured for operable communication with a brake rotor; and
an electro-mechanical actuator configured to selectively move the brake rotor into braking engagement with the friction plate to establish a braking condition to inhibit linear motion of the extensible member between the retracted position and the extended position and out of braking engagement from the friction plate to establish a non-braking condition to freely allow linear motion of the extensible member between the retracted position and the extended position.

18. The closure panel system of claim 17, further including configuring a control system in electrical communication with the electro-mechanical actuator to selectively energize the electro-mechanical actuator in response to receiving a signal from a sensor to establish the non-braking condition and to selectively de-energize the electro-mechanical actuator to establish the braking condition.

19. The closure panel system of claim 18, wherein the electro-mechanical actuator is a solenoid including a biasing member configured to bias the brake rotor into engagement with the friction plate to establish the braking condition when the solenoid is de-energized.

20. The closure panel system of claim 19, wherein the solenoid has a plunger fixed to the brake rotor and an electrical winding adjacent the plunger, the plunger being configured for movement in direct response to the electrical winding being energized, wherein the brake rotor is moved out of braking engagement from the friction plate in direct response to movement of the plunger against bias of the biasing member.
